(19) United States
(12) Patent Application Publication
(10) Pub. No.: US 2012/0128439 A1
(43) Pub. Date: May 24, 2012

(54) Smart Conductive Tool-Part Registration System

(75) Inventors: James Rhett Mayor, Stockbridge, GA (US); Angela Ann Sodemann, Smyrna, GA (US); Stephen Andrew Semidey, Jonesboro, GA (US)

(73) Assignee: Georgia Tech Research Corporation, Atlanta, GA (US)

(21) Appl. No.: 13/266,550

(22) PCT Filed: Apr. 28, 2010
(86) PCT No.: PCT/US10/32794

§ 371 Date: Jan. 15, 2012

Related U.S. Application Data
(60) Provisional application No. 61/173,282, filed on Apr. 28, 2009.

(51) Int. Cl. B23Q 17/22; B23C 9/00

(52) U.S. Cl. 409/132; 409/193

(57) ABSTRACT

A relatively inexpensive and accurate method for micro scale tool touch-off and remaining tool life estimation using advanced methods of tool-workpiece conductivity monitoring. Part registration is based on a conductive circuit detection technique that utilizes an analog DC voltage. A tool life estimation system is provided, and accomplished through the combined application of hardware signal filtering and advanced signal processing techniques implemented on a digital signal processing unit.

### BACKGROUND OF THE INVENTION

1. Field of the Invention

The various embodiments of the present invention relate generally to the micro-machining metal cutting process, specifically to improve the accuracy and productivity of the process by increasing the accuracy of part registration. The part registration process is based on a conductive circuit detection technique that utilizes an analog DC voltage. A tool life estimation system is provided, and accomplished through the combined application of hardware signal filtering and advanced signal processing techniques implemented on a digital signal processing unit.

2. Description of Related Art

Tool registration at the micro-scale, which is generally accepted to those of skill in the art to pertain to tooling that is smaller than one (1) millimeter in diameter, is typically accomplished through skilled operation of the device by micro-machine tool operators. The operator will typically use tactile sense, or micro-scope assisted visual registration of the tool tip onto the surface of the work piece.

Conventional automated techniques include crude tactile sensing systems that drive the tool into the workpiece until a current limit on the feed drive is reached. Accuracy enhancement efforts include averaging of results over multiple tactile surface detection operations. Yet, there are significant limitations to these approaches. From a fundamental standpoint, the size of the tool determines a contact pressure on the work surface that results in elastic deformation, and sometimes plastic deformation depending on the size of the tool. Both the mechanisms of elastic deformation and recovery, and the plastic deformation of the surface of the work material, result in significant registration errors. Furthermore, these errors are dependent on the size of the tool and are exacerbated with decreasing tool size.

Recent technologies include some form of tool registration technique using a conductance approach. Typically, a discrete sensing system is utilized in which contact with the surface results in a prior voltage signal being detected by the data acquisition detection hardware. Yet, conventional approaches cannot provide the precision necessary at the microscale

Precision in tool registration at the microscale is critical because of the micro endmill's extreme sensitivity to axial depth of cut, the high relative precision required on microscale features, and difficulty in precise positioning of the workpiece. Traditional touch-off methods for the macroscale cannot be used at the microscale because of the extremely small tool size.

Touch-off methods that have been proposed for use at the microscale include acoustic emissions, optical methods such as an optical microscope with a charge coupled device (CCD) camera, and force monitoring methods through use of a dynamometer mounted beneath the workpiece. These methods require extensive additional instrumentation and can be expensive.

Also known is a method of tool-workpiece conductivity monitoring to detect tool breakage. However, this method was not considered for registration purposes and the precision of the method not investigated.

In a non-related process, conductive registration techniques have been utilized in the welding field, particularly in sport welding applications, but are not related to smart conductive tool-part registration systems due to the significant difference the scale of the tool that obviates the need to account for variations in surface roughness on the datum surface.

### BRIEF SUMMARY OF THE INVENTION

Briefly described, in preferred form, the present invention is a method of conductivity-based tool registration for micromilling comprising moving a tool and a workpiece relatively toward one another, electrically connecting the workpiece to a voltage source, electrically connecting the voltage source to a voltage measurement location, electrically connecting the voltage measurement location to the tool, measuring the voltage at the voltage measurement location, and stopping the relative movement of the tool and workpiece when a threshold voltage is measured at the voltage measurement location.

In exemplary embodiments, the tool can be rotated from approximately 0-150,000 rpm. Further, the tool and the workpiece have an approach rate from approximately 10-50 μm/s. In many instances, it is assumed the workpiece remains relatively still, while the tool is brought into and out of contact with the workpiece. A spindle can be used to impart the rotation to the tool, and to extend/retract the tool from contact with the workpiece.

In exemplary embodiments, the voltage source supplies from approximately 0.5-2.5 V. Further, the tool is from approximately 0.1-0.6 mm in diameter. The voltage at the voltage measurement location can be sampled at, for example, 0.1 kHz.

The present invention further comprises a device for determining contact between a tool and a workpiece comprising a voltage source, and a voltage measurement location, wherein the workpiece is electrically connected to the voltage source, wherein the voltage source is electrically connected to the voltage measurement location, wherein the voltage measurement location is electrically connected to the tool, and wherein contact between the tool and workpiece is determined upon measuring a voltage at the voltage measurement location.

The present invention further comprises a micromilling system comprising a milling tool, a workpiece, a relative movement assembly capable of moving the tool and workpiece toward one another, a voltage source, and a voltage measurement location, wherein the workpiece is electrically connected to the voltage source, wherein the voltage source is electrically connected to the voltage measurement location, wherein the voltage measurement location is electrically connected to the milling tool, and wherein upon the measurement of a threshold voltage at the voltage measurement location, the relative movement assembly inhibits further movement of the tool and the workpiece toward one another.

The milling tool can have at least one leading tooth, the leading tooth having a trajectory of a helix as it is rotated and moving closer to the workpiece. The helix pitch of the leading tooth in exemplary embodiments is from approximately 0.02-0.004 μm.

The present invention differs from conventional conductivity approaches in at least two areas. Firstly, the present invention utilizes an analog measurement approach, specifically varying the voltage level in order to improve accuracy of the registration process. Secondly, the present invention has the additional capability of determining high fidelity estimates of remaining tool-life by processing and analysis of the characteristics of the potential difference across the work-surface of the work piece and the tool tip interface.

The present invention utilizes advanced methods of tool-workpiece conductivity monitoring as a relatively inexpensive and accurate method for micro scale tool touch-off and remaining tool life estimation. The present invention has shown a higher relative accuracy, within demonstrated sub micron repeatability, provides integrated on-line, real-time tool condition monitoring, and utilizes integrated software algorithms that assess remaining life of tool and predict and schedule tool changes.

These and other objects, features and advantages of the present invention will become more apparent upon reading the following specification.

### BRIEF DESCRIPTION OF THE DRAWINGS

FIG. 1 illustrates a preferred embodiment of a circuit of the present invention.

FIG. 2 is an image of tool teeth according to a preferred embodiment of the present invention.

FIG. 3 is an illustration of tool and workpiece surface geometries.

FIG. 4 is an illustration of a non-rotating tool potential initial contact area.

FIG. 5. is a graph of predicted non-rotating voltage signal during touch-off.

FIG. 6 is an illustration of a rotating tool potential initial contact area.

FIG. 7 is a graph of predicted rotating voltage signal during touch-off.

FIG. 8 is an illustration of tool tooth trajectory during touch-off for fast and slow federates.

FIGS. 9(a)-(d) are scan results for a 100-micron tool, 0.5v, spindle off, 50 μm/s.

FIGS. 10(a)-(d) are scan results for a 100-micron tool, 2.5v, spindle on, 50 μm/s.

FIG. 11 is a graph of mean and standard deviation of touch-off error measured for all 50 micron/s cases tested.

FIG. 12 is a graph of mean and standard deviation of touch-off error measured for all 10 micron/s cases tested.

FIG. 13 is a graph of variance of touch-off error for all 50 micron/s cases tested.

FIG. 14 is a graph of variance of touch-off error for all 10 micron/s cases tested.

FIG. 15 is a graph of 95% confidence interval of touch-off error for the spindle on cases.

### DETAILED DESCRIPTION OF THE INVENTION

The various embodiments of the present invention provide a smart conductive tool-part registration system. Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural references unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named element, device, or method step is present in the element, device or method, but does not exclude the presence of other elements, devices, subsystems or method steps, even if the other such elements, devices, subsystems or method steps have the same function as what is named.

It is also to be understood that the mention of one or more method steps does not preclude the presence of additional method steps or intervening method steps between those steps expressly identified. Further, the language of a process or method in this application or claims does not impose a specific order on the performance of the process or method steps unless the application directly or implicitly requires a particular order. Similarly, it is also to be understood that the mention of one or more components in a assembly or system does not preclude the presence of additional components than those expressly identified.

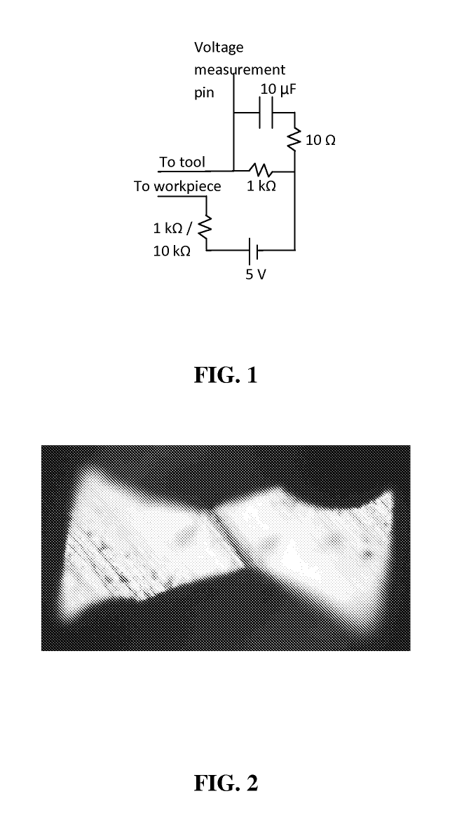

Touch-off is detected by measuring the voltage between ground and the voltage measurement location, which can comprise voltage measurement pin. A preferred embodiment of a conductivity-based touch-off circuit is designed as shown in FIG. 1. As indicated in FIG. 1, the leading resistor value is varied to test the effects of different voltages applied through the tool-workpiece interface. For example, a voltage measurement of <0.1 V can be interpreted as low voltage, and >0.1 V as high. During a touch-off test, the spindle is lowered towards the workpiece, for example, a prepared copper workpiece, at a constant feed rate. The voltage at the pin is sampled at 0.1 kHz. When a threshold voltage is detected on the pin, as defined previously, a servo motor effecting the lowering of the spindle is immediately stopped. Two versions of the present advanced registration method are disclosed: a) spindle-on registration and b) spindle-off registration. The touch-off occurs on the bottom of the tool, which can be shaped as shown in FIG. 2.

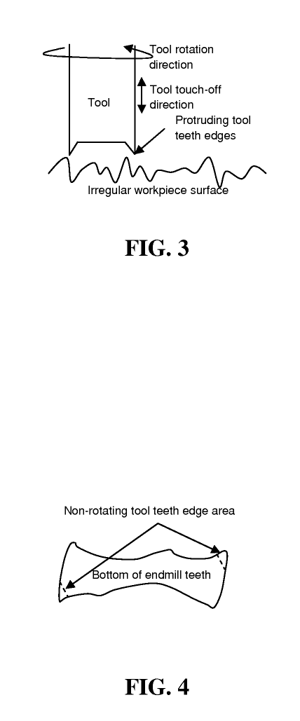

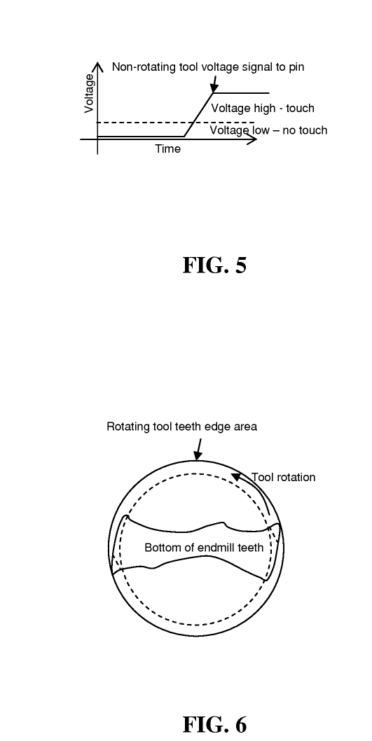

For the voltage signal to pass through the workpiece and through the tool, the tool must make electrical contact with the workpiece. Neither the bottom of the tool nor the top surface of the workpiece is perfectly flat. An example of the geometry of the workpiece surface and endmill teeth are illustrated in FIG. 3, picturing the protruding edges of the tool and a rough, irregular surface on the workpiece.

When the tool is not rotating, the potential initial contact area between the tool and workpiece surface is relatively small, as illustrated in FIG. 4. If the tool is not rotating, a voltage signal will not be seen until there is sufficient contact area. As the contact area increases, resistance of the tool-workpiece interface decreases, increasing the voltage over time, as shown in FIG. 5.

If the tool is rotating, the edges of the teeth can potentially contact the workpiece over a much larger area. The potential initial contact area for a rotating tool is shown in FIG. 6. The rotating teeth will contact the surface periodically at the peaks of the workpiece surface. The voltage signal will be comprised of a series of pulses, as shown in FIG. 7.

A high-frequency pulsed signal is perceived by a low-frequency voltage measurement device as a constant positive voltage signal. The magnitude of the perceived voltage signal increases with increased pulsing frequency. The frequency of the voltage pulses received is dependent on the rotational speed of the cutter and the number of workpiece surface peaks within the rotating tool teeth edge area.

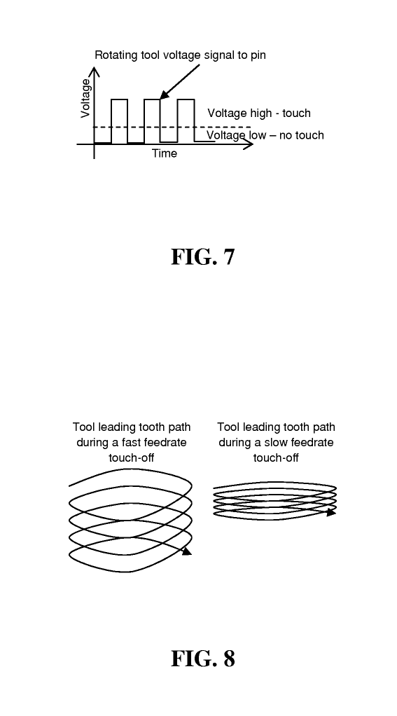

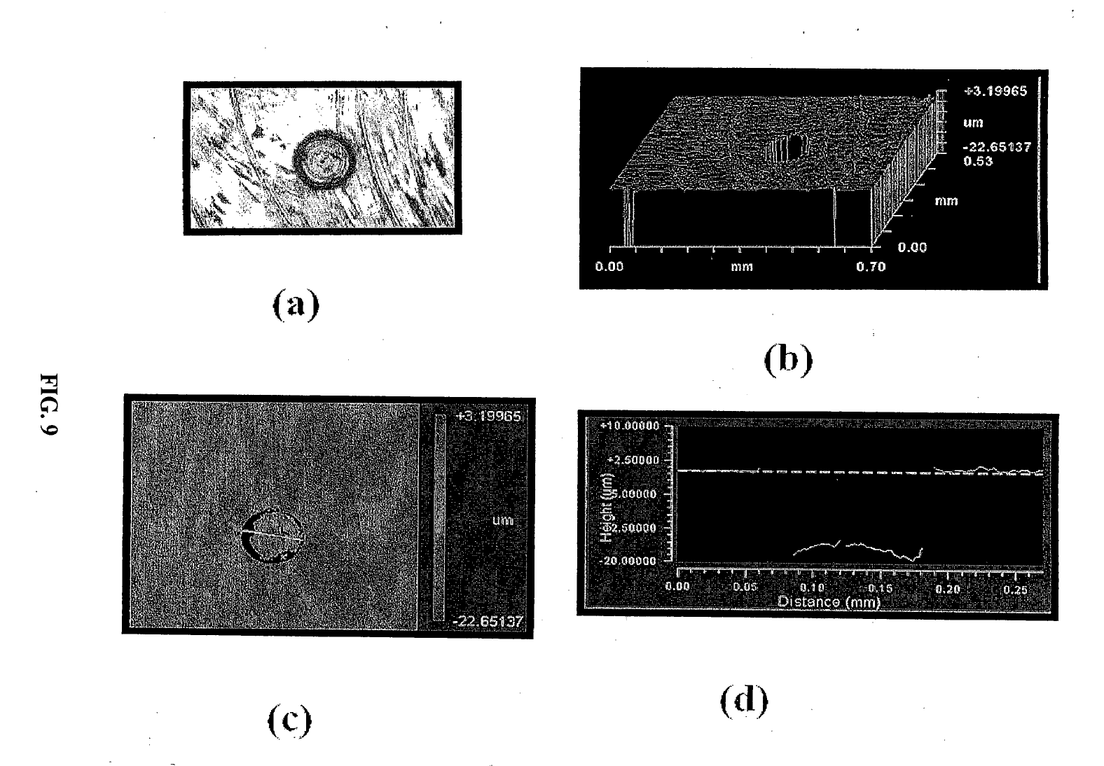

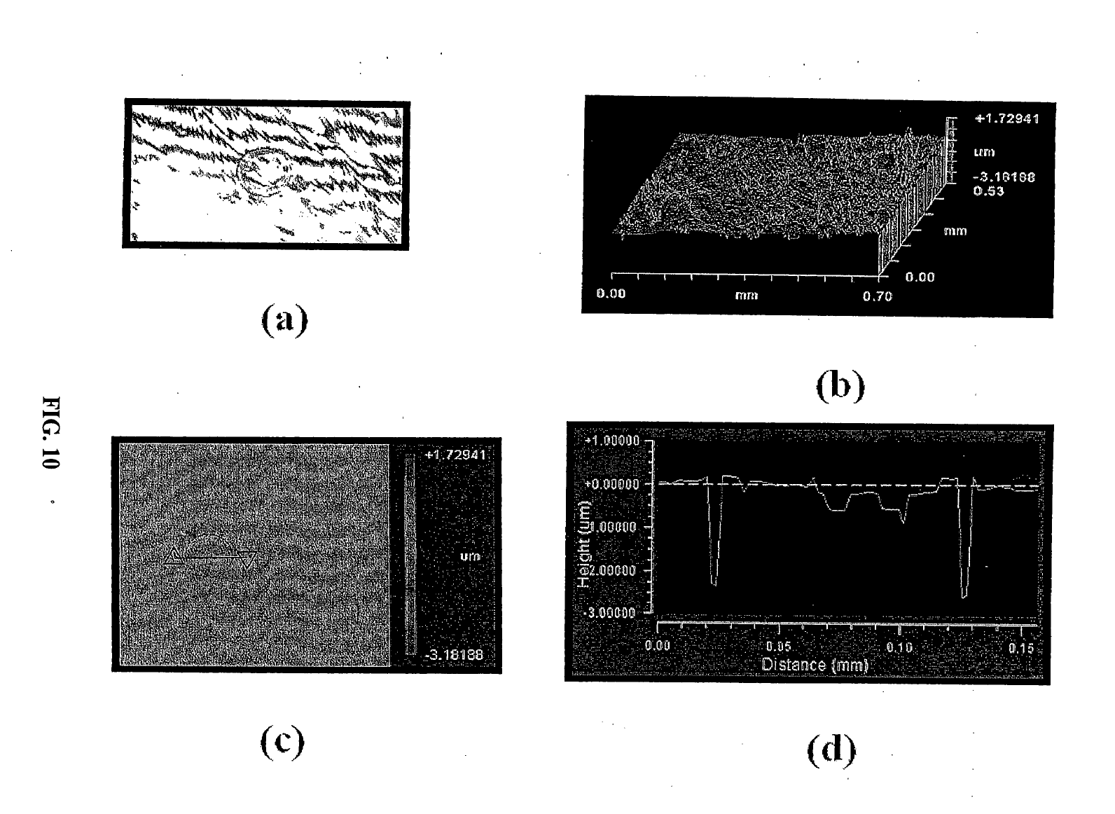

Given a constant surface roughness value, the number of workpiece surface peaks within the rotating tool teeth edge area depends on the tool size. It is predicted that the precision of the touch-off will improve with an increase in the frequency of the pulsed signal. Such a frequency increase can be achieved by increasing spindle speed or increasing tool size. Additionally, it is predicted that touch-off precision can be improved by increasing the magnitude of the voltage pulses by decreasing the resistance in the touch-off circuit. In the process of the touch-off, the spindle is lowered. If the spindle is on during the touch-off, the trajectory of the tool teeth is a helix. The helix pitch is determined by the speed of the touch-off, as shown in FIG. 8.

A helix is defined as indicated in Equation 1.

x(t)=a cos(t)

y(t)=a sin(t)

z(t)=bt (1)

The pitch of the helix is defined as the distance traveled in the z direction during one helix rotation. The pitch of the helix created by the tool tooth trajectory during touch-off is the ratio of feed rate to spindle speed, as shown in Equation 2.

$$pitch = \frac{f}{N} \qquad ( 2 )$$

In Equation 2, N is spindle speed in rpm, and f is the feed rate in the touch-off. It is predicted that a slow feed rate will result in a more accurate touch-off than a high feed rate. However, at the microscale the spindle speed is relatively high compared to the feed rate, so that the pitch remains small; in the tests performed in this study, helix pitches of 0.02 μm and 0.004 μm are studied.

### Experimental Validation

In preparation for touch-off tests, a copper workpiece was faced with a 2 mm diameter tool. The piece was faced with emphasis on providing a smooth surface finish, and later measurements showed the piece to have an average surface roughness of approximately 0.18 μm. The touch-off tool was then mounted, and touch-off tests were performed. During each touch-off test, the spindle was lifted to position the tool tip at approximately 0.3 mm above the surface, so that no contact between tool and workpiece was detected. Parameters were set according to test specification, and a touch-off event was performed. Each combination of parameters was tested five times.

For the spindle off condition tests, the spindle was turned off, the touch-off was performed, and then the spindle was turned on for a few seconds to create a measurable indentation. For the spindle on condition tests, the spindle remained on during the entire test. The depth of the indentation produced by the tool is measured by a white-light interferometer and recorded as touch-off error.

Touch-off tests were performed with a set of variable values to determine the relative significance of the different variable values on the precision of the touch-off. The goal was to find the optimal values for an accurate and fast touch-off independent of the tool size used. A list of the parameters tested is shown in TABLE 1.

TABLE 1
Variables And Values Tested

| Variable | Values |
|---|---|
| Spindle speed | 0, 150000 rpm |
| Approach feed rate | 50, 10 μm/s |
| Voltage | 0.5, 2.5 V |
| Tool size | 0.1, 0.2, 0.6 mm |

After all tests had been performed, the results were examined. Each touch-off location was scanned and the peak-to-valley measurement recorded diametrically across the touch-off location. FIGS. 9(a)-(d) illustrate the scan method for a relatively poor touch-off that was measured to be approximately 20 μm deep. This high-error touch-off was obtained using a 100 μm diameter tool with 0.5 V maximum signal, spindle off, at a 50 μm/s approach feed rate.

FIGS. 10(a)-(d) are images of the scan results for a relatively successful touch-off that was measured to be approximately 2 μm deep. This low-error touch-off was obtained using a 100 μm tool, 2.5 V high signal, spindle on, at a 50 μm/s approach feed rate.

A complete list of the data collected is recorded in TABLE 2. Touch-off tests that were more successful were more difficult to measure. Some of the tests performed resulted in touch-off indentations too small to be measured independent of the workpiece surface roughness. The results of these tests are recorded as in the data as 0.00 μm of measured error.

TABLE 2
Complete Touch-Off Error Data Measured For All Tests

| Parameters | | | | Measured Error [μm] | | | | |
|---|---|---|---|---|---|---|---|---|
| 0.1 mm | 0.5 | Off | 50 | 40.00 | 22.73 | 33.72 | 23.37 | 20.87 |
| | | | 10 | 25.27 | 31.40 | 30.29 | 27.93 | 20.13 |
| | | On | 50 | 4.93 | 7.73 | 7.75 | 9.97 | 8.41 |
| | | | 10 | 3.72 | 4.63 | 3.59 | 2.76 | 0.79 |
| | 2.5 | Off | 50 | 5.44 | 9.96 | 13.75 | 15.75 | 5.31 |
| | | | 10 | 18.91 | 0.00 | 26.13 | 18.03 | 0.00 |
| | | On | 50 | 0.00 | 6.64 | 0.00 | 4.90 | 0.00 |
| | | | 10 | 0.00 | 0.00 | 0.00 | 0.00 | 0.00 |
| 0.2 mm | 0.5 | Off | 50 | 21.10 | 32.87 | 36.59 | 22.31 | 29.89 |
| | | | 10 | 26.21 | 7.47 | 22.27 | 20.26 | 23.77 |
| | | On | 50 | 11.51 | 8.96 | 8.20 | 10.11 | 12.01 |
| | | | 10 | 3.49 | 0.00 | 0.00 | 0.00 | 0.00 |
| | 2.5 | Off | 50 | 32.56 | 41.89 | 11.93 | 40.46 | 44.15 |
| | | | 10 | 45.71 | 38.95 | 19.22 | 44.69 | 0.00 |
| | | On | 50 | 3.95 | 6.10 | 8.06 | 10.42 | 9.72 |
| | | | 10 | 3.94 | 4.03 | 0.00 | 0.00 | 0.00 |
| 0.6 mm | 0.5 | Off | 50 | 26.21 | 19.68 | 11.89 | 20.46 | 13.75 |
| | | | 10 | 9.14 | 20.16 | 9.47 | 24.19 | 22.47 |
| | | On | 50 | 2.05 | 4.16 | 3.08 | 2.87 | 4.14 |
| | | | 10 | 0.00 | 0.78 | 1.02 | 1.71 | 1.71 |
| | 2.5 | Off | 50 | 24.29 | 22.61 | 10.03 | 11.07 | 13.97 |
| | | | 10 | 7.48 | 2.33 | 4.10 | 14.26 | 10.50 |
| | | On | 50 | 1.43 | 2.56 | 1.83 | 2.14 | 1.35 |
| | | | 10 | 1.57 | 1.68 | 1.34 | 1.24 | 0.00 |

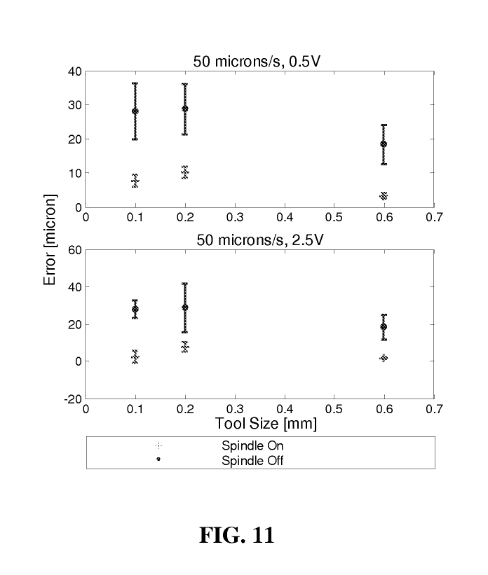

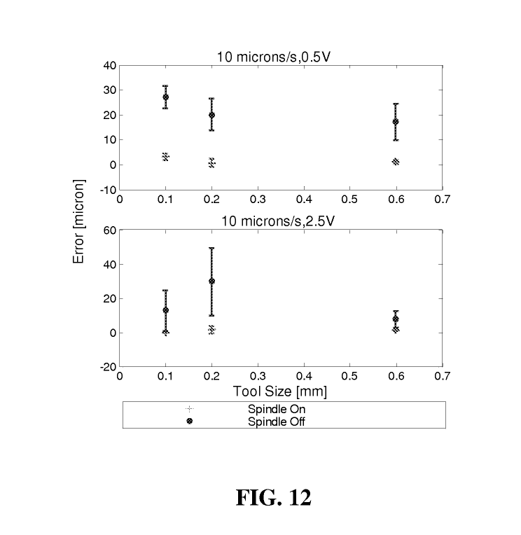

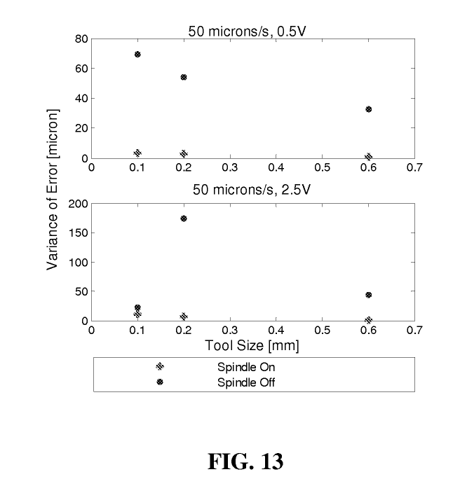

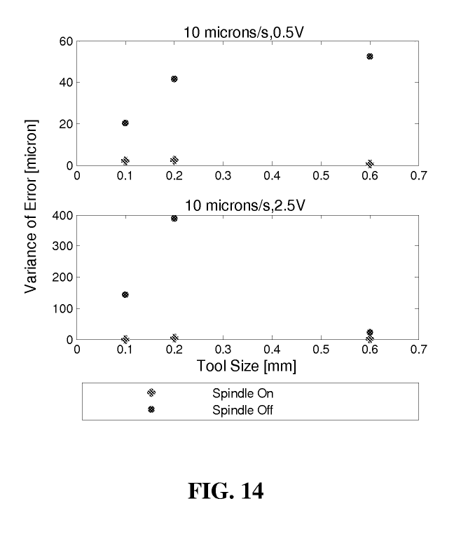

The mean and variance for each test was calculated and plotted. FIGS. 11 and 12 show the measured touch-off error with tool size for all cases tested along with the standard deviation shown by the error bars, FIGS. 13 and 14 illustrate the variance in touch-off error for all cases.

Analysis Of Variance Of Test Results

FIGS. 11 and 12 suggest that the most significant factor for touch-off error reduction may be spindle condition. To verify this, an analysis of variance was carried out on the data. The results are shown in TABLE 3.

TABLE 3
Analysis Of Variance For Various Touch-Off Parameters

| Variable | Symbol | SS | Percent |
|---|---|---|---|
| Approach Feed rate | A | 463.1 | 2.55% |
| Spindle Condition | B | 9139.9 | 50.29% |
| Voltage | C | 334.8 | 1.84% |
| Tool Size | D | 1385.9 | 7.63% |
| Feed rate & Spindle | AxB | 2.8 | 0.02% |
| Feed rate & Voltage | AxC | 13.0 | 0.07% |
| Feed rate & Tool Size | AxD | 175.8 | 0.97% |
| Spindle & Voltage | BxC | 61.8 | 0.34% |
| Spindle & Tool Size | BxD | 531.8 | 2.93% |
| Voltage & Tool Size | CxD | 932.3 | 5.13% |
| Spindle & Voltage & Tool size | BxCxD | 536.3 | 2.95% |
| Feed rate & Spindle & Tool size | AxBxD | 75.8 | 0.42% |
| Feed rate & Voltage & Tool size | AxCxD | 67.8 | 0.37% |
| Feed rate & Spindle & Voltage | AxBxC | 9.2 | 0.05% |
| Feed rate & Spindle & Voltage & | AxBxCxD | 41.5 | 0.23% |
| Tool Size | | | |
| Error | E | 4402.1 | 24.22% |

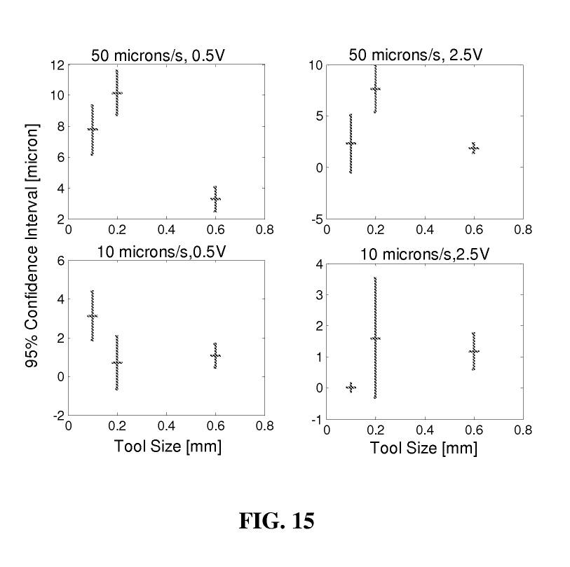

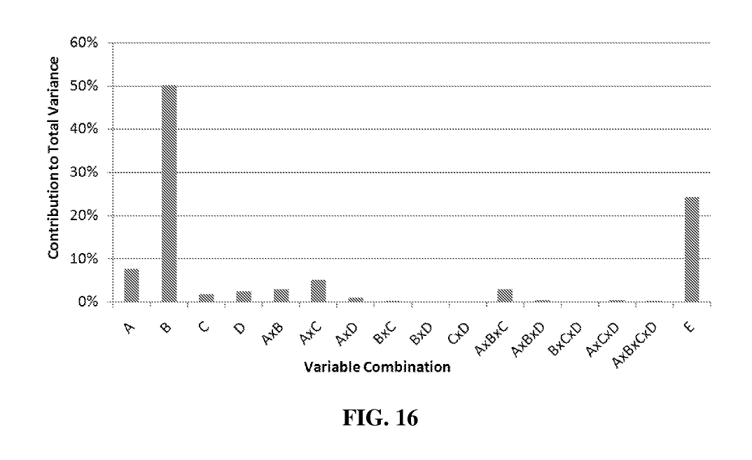

All of the variance percentages in TABLE 3 are charted in FIG. 17. FIGS. 13 and 14 also indicate that there is less variability in the magnitude of touch-off error for the spindle on condition. In order to investigate this, the calculated error mean and 95% confidence interval magnitudes were calculated for all cases and are listed in TABLE 3. The 95% confidence interval calculations confirm that the spindle on condition tests consistently have a smaller confidence interval. The confidence intervals for the spindle on tests are plotted in FIG. 15.

TABLE 4
Mean And 95% Confidence Interval Magnitude For All Cases Tested

| Parameters | | | | | |
|---|---|---|---|---|---|
| Tool | | | Approach | Error | 95% Confidence |
| Size | Voltage | Spindle | Feed | Mean | Interval Magnitude |
| [mm] | [V] | Condition | rate [μm/s] | [μm] | [μm] |
| 0.1 | 0.5 | Off | 50 | 28.14 | 7.29 |
| | | | 10 | 27.00 | 3.95 |
| | | On | 50 | 7.75 | 1.60 |
| | | | 10 | 3.10 | 1.27 |
| | 2.5 | Off | 50 | 10.04 | 4.15 |
| | | | 10 | 12.61 | 10.46 |
| | | On | 50 | 2.31 | 2.82 |
| | | | 10 | 0.00 | 0.00 |
| 0.2 | 0.5 | Off | 50 | 28.73 | 5.66 |
| | | | 10 | 20.00 | 6.43 |
| | | On | 50 | 10.16 | 1.42 |
| | | | 10 | 0.70 | 1.37 |
| | 2.5 | Off | 50 | 34.20 | 11.56 |
| | | | 10 | 29.72 | 17.30 |
| | | On | 50 | 7.65 | 2.33 |
| | | | 10 | 1.59 | 1.91 |
| 0.6 | 0.5 | Off | 50 | 18.40 | 5.01 |
| | | | 10 | 17.09 | 6.35 |
| | | On | 50 | 3.26 | 0.79 |
| | | | 10 | 1.04 | 0.63 |
| | 2.5 | Off | 50 | 16.39 | 5.81 |
| | | | 10 | 7.73 | 4.22 |
| | | On | 50 | 1.86 | 0.44 |
| | | | 10 | 1.17 | 0.59 |

From the results of the analysis of variance it can be determined that all variables tested have an effect on resulting touch-off error, with differing magnitudes. The difference in error with voltage and approach feed rate is relatively insignificant, returning percentage of variance values a unit of magnitude smaller than the more significant variable of spindle condition, which contributes 50.29% of the total variance. FIGS. 11 and 12 indicate that a higher voltage consistently results in less error only in the 50 μm/s, spindle on case. From these figures, approach feed rate is seen to have a small effect on touch-off error.

In one case-spindle off, 2.5 V, for the 0.1 mm tool—the slower approach speed resulted in an increase in error compared with the faster approach feed rate. However, this difference is only a few microns. In one case—0.1 mm tool, 2.5V, spindle on, 10 μm/s approach feed rate—the mean error and the 95% confidence value are both zero. In this case, the touch-off resulted in only a mark on the workpiece surface, the depth of which could not be measured independent of the workpiece surface roughness.

The analysis of variance reveals tool size and spindle speed to be the most significant variables, with spindle speed an order of magnitude more significant than the tool size. The spindle on condition results in significantly less error for all cases tested. In addition to a reduction of error, the spindle on condition results in a much smaller variance among test cases, as illustrated in FIGS. 13 and 14, and reduced 95% confidence interval, as shown in TABLE 4. The analysis of variance indicates that 24.22% of the variance is due to experimental error. This may be due to a number of undiscovered dependencies on untested variables such as runout, temperature variation, and variability in workpiece material composition, among others. However, it is expected that this error component will diminish if a larger number of tests are performed at each parameter set. With a small number of tests performed at each parameter set, small testing anomalies cause a large amount of testing error variation. Additionally, the variance calculations presented in FIGS. 13 and 14 reveal that a large amount of the unexplained variation occurs when the spindle is off. This may be due to surface roughness variations which more dramatically impact the spindle off cases.

Six cases tested provided less than 1 μm of error within the 95% confidence interval. All of the cases are spindle on conditions.

### Results From Validation

The inexpensive conductivity probe method was shown to provide accurate touch-off to within 1 μm under the specific condition of the spindle on. Tool size was also seen to be a moderately significant variable, with a larger tool providing a more accurate touch-off. As predicted, lower approach feed rate and higher voltage also resulted in a more accurate touch-off, but only marginally. By an order of magnitude, the most significant variable for accurate touch-off with the conductivity method is the spindle speed.

Numerous characteristics and advantages have been set forth in the foregoing description, together with details of structure and function. While the invention has been disclosed in several forms, it will be apparent to those skilled in the art that many modifications, additions, and deletions, especially in matters of composition characteristics, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A method of conductivity-based tool registration for micromilling comprising:
moving a tool and a workpiece relatively toward one another;
electrically connecting the workpiece to a voltage source;
electrically connecting the voltage source to a voltage measurement location;
electrically connecting the voltage measurement location to the tool;
measuring the voltage at the voltage measurement location; and
stopping the relative movement of the tool and workpiece when a threshold voltage is measured at the voltage measurement location.

2. The method of claim 1 further comprising the step of rotating the tool from approximately 0-150,000 rpm.

3. The method of claim 1, wherein the tool and the workpiece have an approach rate from approximately 10-50 μm/s when moving relatively toward one another.

4. The method of claim 1, wherein the voltage source supplies from approximately 0.5-2.5 V.

5. The method of claim 1, wherein the tool is from approximately 0.1-0.6 mm in diameter.

6. The method of claim 1, wherein the voltage at the voltage measurement location is sampled at 0.1 kHz.

7. The method of claim 1, wherein stopping the relative movement of the tool and workpiece occurs when a voltage of greater than 0.1 V is measured at the voltage measurement location.

8. A device for determining contact between a tool and a workpiece comprising:
a voltage source; and
a voltage measurement location;
wherein the workpiece is electrically connected to the voltage source;
wherein the voltage source is electrically connected to the voltage measurement location;
wherein the voltage measurement location is electrically connected to the tool;
and wherein contact between the tool and workpiece is determined upon measuring a voltage at the voltage measurement location.

9. A micromilling system comprising:
a milling tool;
a workpiece;
a relative movement assembly capable of moving the tool and workpiece toward one another;
a voltage source; and
a voltage measurement location;
wherein the workpiece is electrically connected to the voltage source;
wherein the voltage source is electrically connected to the voltage measurement location;
wherein the voltage measurement location is electrically connected to the milling tool; and
wherein upon the measurement of a threshold voltage at the voltage measurement location, the relative movement assembly inhibits further movement of the tool and the workpiece toward one another.

10. The system of claim 9, wherein the milling tool is rotated from approximately 0-150,000 rpm.

11. The system of claim 9, wherein the tool and the workpiece have an approach rate from approximately 10-50 μm/s when moving relatively toward one another.

12. The system of claim 9, wherein the voltage source supplies from approximately 0.5-2.5 V.

13. The system of claim 9, wherein the milling tool is from approximately 0.1-0.6 mm in diameter.

14. The system of claim 9, wherein the voltage at the voltage measurement location is sampled at 0.1 kHz.

15. The system of claim 10, wherein the milling tool has at least one leading tooth, the leading tooth having a trajectory of a helix as it is rotated and moving closer to the workpiece, and the helix pitch of the leading tooth from approximately 0.02-0.004 μm.

16. The method of claim 1 further comprising determining an estimate of remaining tool life by processing and analysis of the characteristics of the potential difference across a work-surface of the workpiece and the tool.

17. The device of claim 8, wherein remaining tool life is determined by processing and analysis of the characteristics of the potential difference across a work-surface of the workpiece and the tool.

18. The system of claim 9, wherein remaining milling tool life is determined by processing and analysis of the characteristics of the potential difference across a work-surface of the workpiece and the milling tool.
